(19) United States
(12) Patent Application Publication
(10) Pub. No.: US 2014/0203793 A1
(43) Pub. Date: Jul. 24, 2014

(54) POWER SUPPLY CIRCUIT FOR MEMORY

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: CHAO-RONG LAI, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/144,397

(22) Filed: Dec. 30, 2013

(30) Foreign Application Priority Data
Jan. 24, 2013 (CN) 2013100264880

(51) Int. Cl. H02M 3/158

(52) U.S. Cl. CPC H02M 3/1588
USPC 323/283

(57) ABSTRACT

A voltage pin of a PWM controller is electrically connected to a power source. First and second gate pins of the PWM controller are electrically connected to gates of first and second MOSFETs, respectively. A phase pin of the PWM controller is electrically connected to a source of the first MOSFET and a drain of the second MOSFET, and also electrically connected to an input pin of the PWM controller through a second inductor and a first resistor in that order. A drain of the first MOSFET is connected to the power source through a first inductor. The input pin of the PWM controller is grounded through a second resistor and connected to a first terminal of an electronic switch through a third resistor. A second terminal of the electronic switch is grounded. A control terminal of the electronic switch is connected to a motherboard.

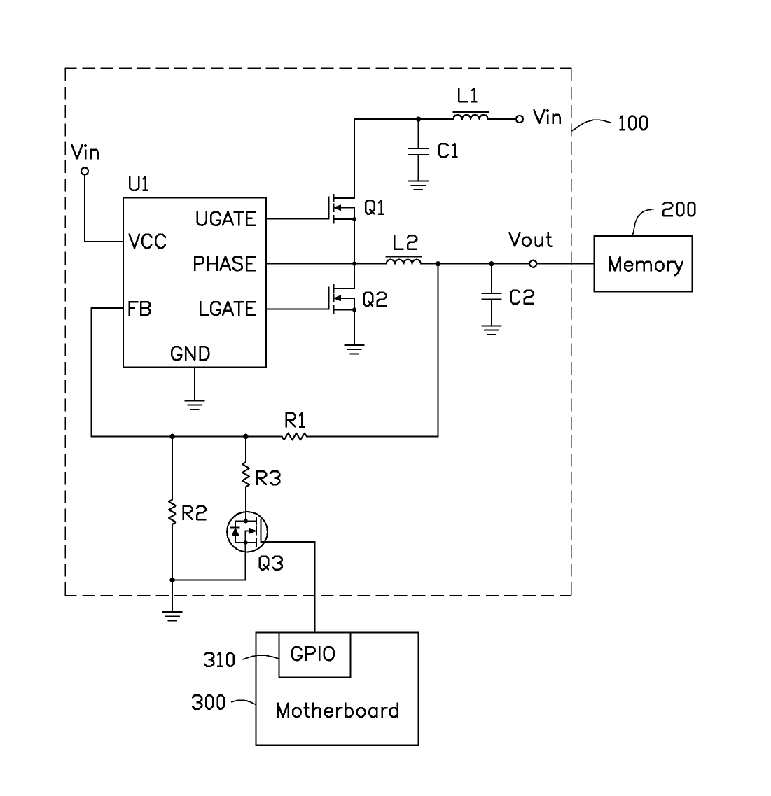

### BACKGROUND

1. Technical Field

The present disclosure relates to a power supply circuit for a memory.

2. Description of Related Art

In general, an operation voltage of a memory, such as a double data rate type two (DDR2) memory, is 1.8±0.1 volts (V). However, different memories require different operation voltages when the memories operate at optimal performance. For example, the operation voltage of one memory may be 1.8 volts (V), while the operation voltage of another memory may be 1.88V. Thus, selection of the memories may be limited for optimizing performance of a personal computer. Therefore, there is room for improvement in the art.

### BRIEF DESCRIPTION OF THE DRAWING

Many aspects of the embodiments can be better understood with reference to the following drawing. The components in the drawing are not necessarily drawn to scale, the emphasis instead being placed upon clearly illustrating the principles of the present embodiments.

The figure is a circuit diagram of an embodiment of a power supply circuit for a memory.

### DETAILED DESCRIPTION

The disclosure, including the drawing, is illustrated by way of example and not by way of limitation. References to “an” or “one” embodiment in this disclosure are not necessarily to the same embodiment, and such references mean “at least one.”

The figure shows an embodiment of a power supply circuit 100. The power supply circuit 100 provides a voltage to a memory 200. The power supply circuit 100 comprises a pulse width modulation (PWM) controller U1, metal-oxide semiconductor field-effect transistors (MOSFETs) Q1and Q2, an electronic switch (such as a MOSFET Q3), resistors R1-R3, inductors L1 and L2, and capacitors C1 and C2.

A voltage pin VCC of the PWM controller U1 is electrically connected to a power supply Vin. In one embodiment, the power source Vin is about +5 volts (V). A first gate pin UGATE of the PWM controller U1 is electrically connected to a gate of the MOSFET Q1. A second gate pin LGATE of the PWM controller U1 is electrically connected to a gate of the MOSFET Q2. A phase pin PHASE of the PWM controller U1 is electrically connected to a source of the MOSFET Q1 and a drain of the MOSFET Q2. A drain of the MOSFET Q1 is electrically connected to the power source Vin through the inductor L1 and grounded through the capacitor C1. A node between the drain of the MOSFET Q2 and the source of the MOSFET Q1 is electrically connected to an input pin FB of the PWM controller U1 through the inductor L2 and the resistor R1 in that order.

The input pin FB of the PWM controller U1 is grounded through the resistor R2 and electrically connected to a drain of the MOSFET Q3 through the resistor R3. A source of the MOSFET Q3 is grounded. A gate of the MOSFET Q3 is electrically connected to a general purpose input/output (GPIO) pin 310 of a motherboard 300.

A node between the inductor L2 and the resistor R1 is used for outputting an output voltage Vout to the memory 200. The node between the inductor L2 and the resistor R1 is also grounded through the capacitor C2. The capacitor C2 is used for filtering noise of the voltage outputted to the memory 200.

In use, according to a standard of the PWM controller U1, the output voltage Vout satisfies the equation: Vout=0.8*(1+r1/r2A), where r1 stands for a resistance of the resistor R1, and r2A stands for an equivalent resistance of the resistors R2 and R3.

In one embodiment, the resistance r1 of the resistor R1 is about 125 ohms, a resistance r2 of the resistor R2 is about 100 ohms, and a resistance r3 of the resistor R3 is about 1328 ohms.

When the GPIO pin 310 outputs a high-level signal, the MOSFET Q3 is turned on, and the resistor R3 is grounded through the MOSFET Q3. The resistors R2 and R3 are connected in parallel. The equivalent resistance r2A=r2*r3/(r2+r3), where r3 stands for the resistance of the resistor R3, r2 stands for the resistance of the resistor R2. Thus, the equivalent resistance r2A is equal to 93 ohms, and the output voltage Vout equals 1.88V.

When the GPIO pin 310 outputs a low-level signal, the MOSFET Q3 is turned off, and the resistor R3 is suspended. The equivalent resistance r2A=r2, thus, the output voltage Vout is 1.8V.

In other embodiments, the output voltage Vout can be changed by setting different resistances of the resistors R1-R3.

In one embodiment, the control terminal, the first terminal, and the second terminal of the electronic switch correspond to the gate, the drain, and the source of the MOSFET Q3, respectively. In other embodiments, the electronic switch may be a bipolar junction transistor, such that the gate, the drain, and the source of the MOSFET Q3 correspond to a base, a collector, and an emitter of the bipolar junction transistor, respectively.

Even though numerous characteristics and advantages of the disclosure have been set forth in the foregoing description, together with details of the structure and function of the disclosure, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. A power supply circuit applicable to provide a voltage to a memory, the power supply circuit comprising:
first and second metal-oxide semiconductor field effect transistors (MOSFETs);
first to third resistors;
first and second inductors;
an electronic switch comprising first to third terminals; and
a pulse width modulation (PWM) controller, wherein a voltage pin of the PWM controller is connected to a power source, a first gate pin of the PWM controller is connected to a gate of the first MOSFET, a second gate pin of the PWM controller is connected to a gate of the second MOSFET, a phase pin of the PWM controller is connected to a source of the first MOSFET and a drain of the second MOSFET, a drain of the first MOSFET is connected to the power source through the first inductor, a node between the drain of the second MOSFET and the source of the first MOSFET is connected to an input pin of the PWM controller through the second inductor and the first resistor in that order, the input pin of the PWM controller is also grounded through the second resistor and also connected to a first terminal of the electronic switch through the third resistor, a second terminal of the electronic switch is grounded, a control terminal of the electronic switch is connected to a general purpose input output pin of a motherboard, a node between the second inductor and the first resistor outputs a first voltage or a second voltage to the memory, the first voltage and second voltage are based on the formula: Vout1=0.8*(1+r1/(r3/(r2+r3)), Vout2 =0.8*(1+r1/r2), where Vout1 and Vout2 are respectively the first and second voltages, r1 stands for a resistance of the first resistor, r2 stands for a resistance of the second resistor, r3 stands for a resistance of the third resistor.

2. The power supply circuit of claim 1, wherein the electronic switch is a third MOSFET, the control terminal, the first terminal, and the second terminal of the electronic switch correspond to the gate, the drain, and the source of the third MOSFET.

3. The power supply circuit of claim 1, further comprising a first capacitor, wherein the first capacitor is connected between the drain of the first MOSFET and ground.

4. The power supply circuit of claim 1, further comprising a second capacitor, wherein a first end of the second capacitor is connected to the node between the second inductor and the first resistor, a second end of the second capacitor is grounded.

5. The power supply circuit of claim 1, wherein Vout1=1.88 volts, Vout2=1.8 volts, r1=125 ohms, r2=100 ohms, and r3=1328 ohms.
